(19) United States
(12) Patent Application Publication
(10) Pub. No.: US 2019/0160357 A1
(43) Pub. Date: May 30, 2019

(54) TRAINING DEVICE AND TRAINING SEAT FOR KITE SURFING AND METHOD THEREOF

(71) Applicant: LANGE ERFOLG GmbH & Co. KG, Merzhausen (DE)

(72) Inventor: Andre Lange, Merzhausen (DE)

(21) Appl. No.: 16/301,052

(22) PCT Filed: Apr. 10, 2017
(86) PCT No.: PCT/IB2017/052066

§ 371 Date: Nov. 13, 2018

(30) Foreign Application Priority Data
May 13, 2016 (DE) 102016108990.7
Mar. 17, 2017 (IB) PCT/IB2017/051561

(51) Int. Cl. A63B 69/00; A63B 21/00; G09B 9/06

(52) U.S. Cl. CPC A63B 69/0066; A63B 21/4009; A63B 69/0064; A63B 2225/605; A63B 2208/0204; A63B 2208/0233; G09B 9/066

(57) ABSTRACT

A training device having a platform for receiving at least one person; at least one anchoring point for fastening a securing means that secures the person on the training device; a vertical rotation axis Z, about which the training device can be mounted rotatably or is mounted rotatably. The anchoring point is arranged at or above the height of the buttocks region of the person, and the training device is rotatable about this rotary axis Z by means of forces acting on the platform.

### CROSS REFERENCE TO RELATED APPLICATIONS

This is a US national phase application under 35 USC § 371 of International Patent Application No. PCT/IB2017/052066 filed Apr. 10, 2017, which itself claims priority to German Application No. 102016108990.7 filed May 13, 2016, and International Patent Application No. PCT/IB2017/051561 filed Mar. 17, 2017. Each of the applications referred to in this paragraph are herein incorporated by reference in their entireties.

### TECHNICAL FIELD

The invention relates to a training device and a training seat for learning the operation of flying apparatuses for pulling persons. In particular, the invention relates to a training device and a training seat for kite surfers, as well as a method for the operation thereof.

### BACKGROUND OF THE INVENTION

Sports equipment, which pulls persons on- or off shore is becoming increasingly popular. In these types of sports, which, amongst others, include so-called kite surfing, a person is connected to a flying apparatus by means of a rope or the like. During flight, the flying apparatus exerts a tractive force on the person, which in turn typically stands or sits on an auxiliary means such as a floating body or a vehicle provided with wheels or skids. Using correspondingly strong flying apparatuses, it is even possible to omit the auxiliary means and to glide along the water surface with mere feet.

Wind-driven devices such as stunt kites (“kites”) are typically used as flying apparatuses. Such devices can accordingly be used only under suitable wind conditions, since, in the event of too little or no wind, they provide too low of a force, and in the event of too much wind, they become impossible to handle. An exemplary flying apparatus is described in publication DE 29 33 050 A1 from the year 1979.

Also known are traction drones, which are substantially independent of wind conditions. The disadvantage of such motor-driven devices is the energy consumption, the often-limited operating time, and also the noise emission, can be undesirable.

In particular, the wind-driven devices require a considerable training during handling, since the user must ensure during operation that the flying apparatus remains in the air, which is difficult in the case of frequently changing wind conditions and requires experience, and is also responsible for controlling the flying apparatus so that it also pulls in a desired direction.

Control is usually carried out with the aid of two or more traction cables, which allow the aircraft to tilt to the side depending on the forces exerted on the cables by hands of the user, into which it then tries to fly. Often, the cables are attached to the ends of a transverse rod, called “crossbar”. The latter is held in front of the body of the user. By means of a detachable connection, it is connected to the so-called trapezium, a harness which is attached in the hip region of the user. The trapezium distributes the high tensile forces of the kite onto the body and thus counteracts premature fatigue of the arms holding the bar.

The complex interplay of the different components requires a large amount of experience during use, which can be obtained essentially only by practical training. For this purpose, it is first necessary to search for a suitable training location. In the case of kite surfing, this means that the student has to be able to stand in the water, and that the wind conditions are suitable and stable, which is not always the case in close vicinity to the beach. The kite student trains attached to the kite, standing; alone, or held by a person at the harness. Due to the multiple repetition of the steps “rising to the board”, “attempting to bring the steering kite into the air and to keep it there”, “setting board in motion and remaining thereon”, and finally “steering kite in a desired direction”, the student often experiences premature fatigue phenomena.

These are further increased by the high stimulus effect of water, wind and sun. Frequent pauses are therefore indispensable, which shortens the actual practice time accordingly. The practically simultaneous execution of the above-mentioned steps is difficult and can lead to frustration. If the kite is inadvertently incorrectly steered, a gust suddenly catches the kite, or the kite has a technical problem, very large forces can occur which can entrain the student who is fixedly connected to the kite. As a result, the students, the securing person, but also passers or other athletes are repeatedly put at risk. In particular, the region which is suitable for training is also frequented by already experienced athletes, particularly just when the wind and weather conditions are also suitable for the student. The risk of accidents caused by collisions is therefore quite relevant. Since during training, the student is repeatedly dragged behind the kite, a continuous shift of the danger spots occurs, so that further increased attentiveness of the surrounding persons is essential, but is not always given. Finally, the student requires significant force and time in order to move back against the wind with the pulling kite. This as well slows down the learning rate and increases risks.

Training devices are therefore known from the prior art, which intend to simplify learning the techniques required for handling wind-driven sports equipment. Publication DE 10 2010 053 320 A1 proposes a device for this purpose, which is constructed and operated completely in the dry, for example in a flat. The device is used in particular to train jumps with a kiteboard, which require experience and technique. However, this device is not suitable for training basic skills.

A system suitable for learning the fundamental skills of wind surfing is known from publication DE 26 581 10 A1. Guides are tensioned between two fixedly anchored end points, on which guides the surfboards which are suspended by means of eyelets or the like can be moved. A device of this type is, however, not very suitable for learning kite surfing, since just the essential skills of climbing on the board on one hand, and controlling the kite on the other hand, are not to be carried out when wind surfing. Only an already quite experienced student will get along with the described system, which would not be in need of the same.

Different types of sub-frames that can be mounted on the beach are also known from the windsurfing field; by way of example, reference is made to publication DE 34 12 721 A1. Even though a kite student can in principle carry out certain exercises with such a system with regard to controlling the kite, a great risk exists that he can be dragged off the system due to very strong sudden forces resulting from a gust. In addition, such a stationary installation which is to be used on land is less suitable to develop a sense for the relationship between the wind and the travel direction.

A system providing a realistic sense for the movement on the water is disclosed in publication WO 2010/015788 A4. A flow system to be installed on land generates a continuous flow of water on which the student can glide. The latter holds onto a stationary fastened cable or the like. The system cannot be used for learning kite surfing because of the lack of wind. Wind-generating systems are also known, for example, from the publication DE 39 00 837 A1; however, these have not been established.

### SUMMARY OF THE INVENTION

The object of the invention is to avoid or reduce the disadvantages described above. The invention is therefore intended to reduce the risks associated with the training of kite surfing. The invention shall improve the student's learning effect, help to avoid injuries, and reduce fatigue as well as frustration.

The training device according to the invention serves (as well as the training seat described further below) for learning the operation of flying apparatuses pulling persons, such as e.g. steering kites/kites, or flying drones. It includes a platform for standing, sitting, kneeling or lying reception of at least one person, at least one anchoring point for the fastening a securing means which secures the person to the training device, and a vertical rotary axis about which the training device can be mounted rotatably or is mounted rotatably.

The platform thus serves to receive at least one, and preferably more, students and particularly preferably also the teacher. The term “platform” is broadly interpreted and refers not only to devices having continuous surfaces, but also frames and the like; it is accordingly to be understood functionally.

The anchoring point serves for securing the student, and in particular all persons, which are actually occupied with the training of kite surfing. According to the invention, the anchoring point is arranged in or above the height of the buttocks region of the person, for example at a height of at least 25, 40, 50, 75 and/or 100 centimeters. From the viewpoint of the respective person, the securing is preferably affected on his/her rear side, i.e. in the region of his/her back/buttocks, etc. However, it is also possible that the securing takes place alternatively or additionally at the front or uni- or bilaterally. The securing can be affected by tension-absorbing securing means (cables, straps), or by pressure-absorbing securing means (supports, railings, gratings). The task of the anchoring point and of the securing means lies in the absorption and forwarding of the forces acting on the student by the kite. Due to the securing, the student is not torn by the kite from the training device even when unexpectedly high wind forces occur. This significantly reduces fatigue and risk of injury. The student can concentrate completely on the control of the kite, without being adversely affected by the possibility of the occurrence of an unexpected risk.

It should be added that the securing is particularly preferably detachable manually and/or automatically. This means that (e.g. in the event of an urgent need for leaving the practice device) the securing means should also be accordingly easy to unlock by the student, the teacher or an automatic mechanism.

The vertical rotary axis about which the training device can be, or is, rotatably supported, enables the training device to rotate about this rotary axis due to the external (wind-) forces that are transferred from the kite to the student, and through the securing means and the anchoring point to the body of the training device. Thus, the kite student can, by means of the kite controlled by him/her, rotate the training device into or out of the wind, and thus receives a highly realistic sense for the interrelations of the kite control on one hand and the thus achievable movements of his/her “board” which is, during training, provided by the platform itself. Due to the typically high inertia which the platform has in comparison to a kiteboard, however, the movements take place much more slowly, so that the student can become accustomed to the interrelations step by step, without being overburdened by the movements that otherwise must be carried out very exactly, and by the rapid reactions of the board.

According to the invention, the rotary axis is completely, or within constructively predefined limits, stationary relatively to the platform. This means that there is a predetermined point or region on the platform which is connected to it or moves only together with it, through which the rotary axis runs at any time. This point or region can lie at the edge of the platform; however, it is preferably arranged in the center of the platform.

The invention thus effectively reduces the risks associated with the training of the kite surfing. It improves the student's learning effect, helps to avoid injuries, and reduces fatigue as well as frustration.

According to one embodiment, the completely stationary rotary axis is provided by means of a rotary joint which is located at the underside, at the circumference, or at the upper side of the platform. The term “universal joint” is to be understood functionally here; accordingly, all known types of bearings allowing a rotation about a rotary axis fall within the term. The rotary joint can be formed, for example, by an eyelet through which a cable or a chain is hung, or by a rotatably mounted rod about which the platform can rotate. The platform can be suspended, but preferably, it has the rotary joint on its underside. Even when the platform interacts with its outer edges with the walls of a round cage on which it can slide, in this way, a (functional) rotary joint is provided.

According to another embodiment, the rotary axis which is stationary within constructively predefined boundaries is provided by means of a coupling element which is slidably moveable between two end stops. Accordingly, the rotary axis is stationary within a region, and not only in one point. However, this region can be determined exactly in terms of design and is furthermore located in the immediate vicinity of and connection to the platform.

An example of such an embodiment is a coupling element providing a roller as a rotary axis, wherein the roller can slide on a cable, which is fastened to the outer or underside of the platform at two points serving as end stops. The roller itself can, for example, be anchored to the sea bed by means of a cable.

Through the (limited) displacement of the coupling element, a first reaction of the platform can take place immediately, and initially without the slower rotation. In addition, also in the case of a tautened anchor cable (thus largely preventing a rotation about the anchor point on the ground) such a construction allows a relatively fast response (rotation) of the platform to laterally acting tensile forces, even when the platform is large or heavy and is thus too slow for a reaction speed which would be helpful for learning.

According to another embodiment, the training device has skids or a slidable underside for the locomotion on ice and snow. Particularly preferred, the training device does not have a stationary rotary axis; however, it is conceivable for the latter to be optionally added, for example by releasing a weight which is accordingly rotatably connected to the platform. With such a platform, in particular the popular so-called “snow kiting” can be trained.

According to a further embodiment, the training device has rollers for the locomotion on solid grounds. The rollers can in turn be rotatably mounted, for example in the manner of a shopping cart, so that the platform can be rotated in the horizontal about a vertical rotary axis. Here, too, the stationary characteristics of the rotary axis can optionally be added. Such a training device with a fixed rotary axis can also be operated at small locations, and in case of a variable rotary axis on wide roads, disused flight fields, flat lawn areas or dried-out salt seas.

However, preferably, the training device is floatable. It is clear that in all cases described, but very particularly in the floatable case, the training device should be safe from tilting or capsizing. This can be achieved by means of an accordingly sized or accordingly far-reaching/heavy booms, which preferably point in the direction opposite to the kite. If a kite tries to draw the platform in a certain direction, the boom is arranged just on the opposite side of the platform. The boom or weight can contain a solid or a liquid material, such as particularly preferred water.

Preferably, the training device comprises a (single- or also multi-part) floating body which provides a permanent or temporary buoyancy. This means that the training device can float on the water by itself without further auxiliary means such as, for example, a crane or a underground supporting the training device.

According to a preferred embodiment, the training device has an approximately circular base surface. It is clear that regular polygons also fall under the base surface, which can also be referred to as the “basic shape”. It is also clear that the training device can have bulges and/or recesses on its side, without losing said basic shape. The circular shape has the advantage that a larger number of students can take place on it, which, for example, look in direction of the outside of the platform, whereas their backs face one another. Accordingly, in a simple manner, each student has an identical space available, with an identical distance to the edge of the platform. Each student thus finds identical practice conditions independently of the selected seat.

According to other embodiments, the platform has a rectangular, in particular square, or a semicircular base surface.

Preferably, the training device has a support body for the feet, and/or a support body for the back of a person.

The support body for the feet serves in particular to absorb pressure forces, so that the student, which holds and controls a kite, is located, can press with his/her feet against the support body for the feet. Such a movement is comparable to the later pushing off the angled feet from the board.

The support body for the back likewise serves in particular to absorb pressure forces, in order to allow for a comfortable resting, for example during rest pauses. In addition and preferably, the support body for the back serves also for providing the anchoring point or points, on which the securing means for the student or students is/are attached. Accordingly, the support body for the back should also be suitable for absorbing tensile forces.

According to one embodiment, the single-part or multi-part support body/bodies is/are arranged at the edge of the platform or in the central region of the platform. Particularly preferred, the support body for the feet is arranged on the (circumferential) edge region of the platform, and the support body for the back is arranged in its central region, if the platform has a circular or rectangular base surface. In the case of a semicircular base surface, the support body for the feet is located on the arcuate outer edge, and the support body for the back in the center of the semi-circle or along the straight outer edge.

According to one embodiment, the support body for the feet has a region which can, by means of the feet of a person, be tilted laterally or forward/backward, and/or be rotated around a central axis. Such tilting movements are also carried out during riding a board in order to control the speed or to ride in a certain direction. As a result of the provision of such a region, the student can accordingly carry out realistic movements with his feet while controlling the kite. It is possible to use the movements for controlling the platform in order to generate a positive feedback.

In concrete terms, the support body can be designed either as a body which is deformable by the feet, or as a rigid body which is supported moveable on the platform according to said degrees of freedom.

Deformable by the feet is, for example, an inflatable or otherwise elastic ground against which the feet can be bear. In particular, the above-described circumferential support body for the feet is considered here.

A rigidly designed region can be realized, for example, by a plate-like or frame-like construction, which is mounted on the platform in accordance with the desired degrees of freedom. The specific design of an according construction is well known to the person skilled in the art and therefore does not require any further explanation.

According to a further embodiment, the platform comprises a recess at its circumference. The recess can be an opening pointing towards the side of the training device in an otherwise circumferential railing or support region, so that persons or objects can easily climb the platform through the opening. It can also be a (floor-) opening present in the platform through which water can possibly get into the area of the base surface of the training device. In case of a circular base surface, the shape of such a recess can be segment-shaped and can, for example, comprise one fifth or one sixth of the circumference.

According to one embodiment, the recess is provided for the reception of a board like sports device serving as a rigidly designed support body for the feet, wherein the sports device can be supported in the recess according to said degrees of freedom. In other words, the recess can receive a kiteboard or a device which is comparable with regard to training purposes, which is attached to the platform, but is mounted so as to be tiltable and/or rotatable in order for the student to be able to carry out corresponding movements on the device, and in particular when he simultaneously controls the kite. Optionally, a scale can also be provided for displaying the inclination and/or rotation of the board-like sports device. The stiffness of the joints, i.e. the force with which the board-like sports device tries to move into a “rest position” is preferably adjustable.

In another embodiment, the recess has a deformable floor and provides holding means for a fixation to a person's feet. The floor of the platform can accordingly comprise, for example, loops which are preferably adjustable in position and size, or hollows which can receive the feet of a student, so that the latter always takes the same position on said region.

According to another embodiment, the recess is suitable for the reception of a separate training seat which receives a person. Such a training seat is described in more detail further below.

In case of a floatable training device, it is further possible that the same has at least one braking body which is located below or laterally to the platform and which is attached to the same, and which is or can be filled with water or a solid material. The braking body has the important task to improve the safety from capsizing and to increase the inertia of the training device, so that it cannot be moved forward by a student too easily or quickly. In addition, it remains more steady in the water even in case of stronger waves.

According to one embodiment, the braking body is provided by means of an additional subfloor or two skids, and has at least one opening through which it can be filled and/or emptied. According to the first-described embodiment, the platform accordingly has sort of a second floor on its underside, which is, for the greatest possible effectiveness, also as large as possible. This second floor is connected to the underside of the platform such that a substantially closed or closable, water-inflatable bag-like structure is provided. By filling this structure, the mass of the training device increases significantly, which results in the according positive effects. If the structure is closed after filling, its filling content does also not change during movements of the training device. However, in case of a displacement of the training device, it is particularly desirable having to move the smallest mass possible. Then, the structure can be emptied actively or passively (see further below).

According to a preferred embodiment, the training device comprises also a dragging device. By aid of the same, the training device can be dragged from one place to another easily. In particular, a cable, a chain or a rod, which is connected to the platform in a (functionally-) articulated manner, can be used for this purpose.

In case that the training device has the aforesaid braking body, said dragging device engages, in a view parallel to the rotary axis, in a region opposing to the at least one opening of the braking body which is then also present. This means that the at least one opening points in the direction opposite to the drag direction. The drag direction is in turn the direction into which the training device can preferably be moved by means of the dragging device.

The advantage of such an arrangement is that an initially filled braking body is practically automatically emptied when the training device is dragged in said preferred direction. This is due to the fact that the bow of the training device is slightly raised during dragging, so that water contained in the braking body is driven out by the flow front which enters below the bow and travels towards the stern. As soon as the training device stops, this effect comes to a standstill; supported by the addition of weights to the underside of the braking body, little by little, the latter automatically inflates again.

According to another embodiment, the training device comprises an actively acting pumping device for filling and/or emptying the braking body.

According to a further embodiment, the braking body is designed to be closable. In this way, water which has already been absorbed in the volume can be kept there, even when the training device moves, which could result in an emptying of the braking body. An undesired filling of the still empty braking body can also be prevented, for example during dragging of the training device in a direction into which the opening points as well.

According to a further embodiment of the training device having such support bodies, seats are tensioned between the support body for the feet and the support body for the back. In these, one student can rest in a comfortable position, while another student trains on the kite. Tensioned seats have the advantage of low weight and low risk of injury and can easily be assembled and removed again in a simple manner. In addition, they can also serve as rain and wind protection if the crew is surprised by a windstorm.

According to another embodiment, the training device further includes a motor drive and/or a mounting for a vehicle suitable for the pushing and/or pulling propulsion of the training device. By means of a dedicated motor, the training device can travel, in a particularly simple manner, at least shorter distances, for example from the bank/beach to the open water/sea. For longer distances or higher speeds, it is preferable for an additional motorboat or the like to serve as a drive. In addition to the already described function of dragging, it is also possible to directly pull or push the training device. This can also be achieved with a so-called “jet ski”. It is therefore conceivable that the training device has an according opening (indentation) into which such a tractive or thrust device can be inserted, so that temporarily, training device and pulling or pushing device form one unit. In addition, the tractive or thrust device also increases the training device's safety from capsizing.

Analogous considerations apply to a training device for operation on a solid underground such as asphalt or ice.

According to another embodiment, the training device comprises an optical signaling device. The latter serves to the transmission of optical signals, for example between a motorboat pulling the training device, and the crew of the training device. Such signaling devices are known as such and therefore require no further explanation.

It is further preferred that the training device has a centrally arranged point for coupling to a safety line for the flying apparatus. Thus, the safety line does not have to be passed on from student to student when a change is made, but the line remains at the central coupling point during the entire training time. The latter can particularly preferably be arranged at an elevated position in the center of the training device, for example on the upper side of the support body for the back.

The training device can also be equipped with cameras for video recording in order to be able to provide the student with video feedback.

It can have intercom systems, a music system, a generator and/or a device for generating solar power.

It can have a cable winch, by means of which it can be pulled in a simple manner, for example, onto land or to another boat.

It can be equipped with devices for storing kites etc.

It can also be equipped with mountings for receiving the bar, the safety devices, or for unrolling the lines.

The invention also relates to a training seat for learning the operation of flying apparatuses pulling persons, including a seating area for receiving the person, an inclined tread surface for supporting the feet of a person, as well as securing means for holding back the person to the training seat. The training seat is characterized in that it has a tilt axis about which at least the tread surface can be tilted forwards, and also provides an inhibiting device for limiting the tilting movement.

The seating area can be provided as a fixed frame, or can be designed from flexible, e.g. inflatable, material. The term “area” is to be understood functionally and comprises other types of configuration as well in which a person can sit or lie, for example a frame which is covered with a cloth or a net, and/or a device which supports only parts of the back and the buttocks of the person.

The tread surface absorbs directly (by means of contact with the feet) or indirectly (by means of a kiteboard contacted with the feet) the compressive forces which act on the student by the flying apparatus.

The securing means is designed according to the type described further above and comprises in particular belts or the like which hold the student tight in the training seat, wherein preferably, however, a certain movement clearance (e.g. 5 to 25 cm distance from the back) is present, while, on the other hand, overturning to the front or to the side can be prevented. Optionally, the belts have an emergency closure, so that in case of an emergency, rapid separation from the training seat is ensured.

According to the invention, the training seat has a tilt axis about which it, or at least the tread surface, can be tilted forwards and thus erect, i.e. in the direction into which the student looks and into which the kite pulls. As a result of the pull of the flying apparatus and the simultaneous pressure of the feet on the tread surface, the student is brought from the seated position into the standing position. The feet remain on the tread surface which tilts as well, thus being able to simulate the tilting movements of a kiteboard.

In order that the movement does not result in a complete forward tilting, the training seat has an inhibiting device for limiting the tilting movement, which can for example be provided by straps, guides or the like, which are attached to the rear side or to the sides of the training seat. These also prevent excessive lateral inclination. Preferably, the inhibiting device allows a maximum erection of the training seat into an approximately vertical position, wherein its “rest position” lies horizontally or at an angle of, for example, 20 to 60 degrees to the horizontal. In contrast, the tread surface is already angled in the rest position, for example by 115 degrees, and can tilt up to an angle of slightly less than/above 180 degrees, so that it then runs approximately parallel to the water surface.

If tension in the flying apparatus decreases again, the student first falls onto the training seat, and, if the latter can be tilted as a whole, back with the latter to the rear, or towards the horizontal, whereby the training seat itself can optionally be decelerated by a brake body. The student is thus again in a seated position and can initiate the next starting process of the flying apparatus.

If only the tread surface is tiltable, the student only falls back onto the training seat.

By means of the training seat according to the invention, a riskless and fatigue-free training, in particular of the starting process, but also of subsequent control of the kite, is possible. The student has extensive control over the flying apparatus, but cannot be drawn into the water, as in conventional trainings performed directly on a kiteboard.

According to one embodiment, the training seat has, as a tread surface, a direct receptacle for the feet, or a receptacle for a kiteboard. Both types of the receptacles have already been described further above in the context of the training device and therefore do not need to be repeated again.

The tread surface, or the kiteboard fastened thereon, can preferably be pivoted and rotated in a plurality of directions (i.e. not only forwards), so that riding on the edge of the tread surface, or of the kiteboard, is possible. For this purpose, the supporting underside of the tread surface can be wedge-shaped, cylindrical or hemispherical. In addition, the tread surface, or the kiteboard fastened thereon, can be displaced diagonally forwards in drag direction of the flying apparatus. This can be achieved, for example, by an according fastening means using rubber cables which, after standing up, retract the tread surface into its original position.

However, a diagonal movement clearance of the tread surface, or of the kite board fastened thereon, can also be made possible by means of a mechanical guide. For bearing, the board can slide on rollers, wherein end stops are provided for limiting the free movement.

According to one embodiment, the tilt axis can move within certain limits.

So, the training seat which can then move as a whole around the (moving) tilt axis and which is designed, for example, as a seat shell, can be glideably supported in a rigid support which provides a path that has the shape of a circular segment. The term “circular section” is to be interpreted broadly here, and other convex arc shapes fall under this definition as well. The rigid support can be, for example, a platform according to the above definition, or a boat, a landing stage, or a land vehicle. Preferably, the training seat itself then has a half shell shape which can slidingly co-operate with the circular-segment-shaped track.

When the training seat is floatable and has a rear side in the form of a circular segment, it can also slide in the water on an (approximately) circular-segment-shaped path. In this embodiment, the sliding track is thus replaced by an interaction of the rounded rear side of the training seat in the water. Nevertheless, the forward tilting according to the invention is also ensured in this embodiment, and the position of the “virtual” tilt axis is specified by the shape of the training seat, wherein the latter is then also influenced, for example, by its weight including the student, but remains then, however, unchanged during use.

Finally, it is possible that the training seat which is floatable (or which is attached to a floatable base) provides in the region of the tread surface one or more round or cylindrical floating bodies about which the training seat can tilt. This movement also allows for the forward tilting according to the invention. The tilt axis then runs through the centre points of the balls or along the longitudinal axis of the cylinder.

According to a further embodiment, the tilt axis is provided by an axis extending horizontally in the region of the tread surface which can be attached to a rigid platform. Thus, in this case, the training seat has a defined axis which is located in the foot region of the student.

Accordingly, in the above-described erecting movement, the feet only travel a short distance, whereas the head covers the longest path.

The axis can be provided by a rod, by belts, eyelets, a zipper or other components which are physically always positioned at the same location.

According to one embodiment, the training seat, or a part of the same, can be tilted together with the tread surface around the tilt axis. The tread surface is thus fixedly connected to the tiltable training seat (or a tiltable part thereof). The training seat can thus also be divided, wherein the lower part (which is closer to the feet and legs), the middle part (which is for example located in the buttocks region), or the upper part (which is closer to the back) can tilt together with the tread surface, whereas the remaining part of the seating area is fixedly connected or connectable to the platform and does not tilt. A plurality of parts can also tilt together, and other parts can be fixed.

According to a further embodiment, only the tread surface can be tilted around the tilt axis. This means that not the seat as a whole, but only the foot region on which the feet of the student are standing, can actually tilt forwards. The remaining part of the training seat, in particular the seating area, remains immobile and is connected to the rigid platform.

According to a preferred embodiment of the training seat having a tiltable tread surface, the latter has in the center, or on at least one side, at least one post which is approximately parallel to the seating area. The end thereof typically extends at least as far as the buttocks region of the seating area, or it can be extended into this region. The securing means can be attached to the at least one post. Preferably, the length of the post is variable, and/or it has a plurality of coupling points for the securing means in order to be adaptable to different body sizes. The post can also be shorter, and then lengthened accordingly by means of a further rod or belt. When the tread surface tilts forwards, the post (and with it the securing means) tilts with it. The angle between the at least one post and the tread surface is preferably 75 to 105 degrees, and particularly preferably 90 degrees.

According to a particularly preferred embodiment, the tread surface has two posts which are mounted bi-laterally, wherein the ends of which end freely, or are connected by means of at least one transverse rod. At both posts, and particularly at their ends, or at the transverse rod, respectively, a harness is, or can be, attached, which serves as securing means.

The transverse rod increases the stability of the structure. When a transverse rod is present, it is advantageous that the seating area has a recess or a cut-out at a corresponding point, so that the transverse rod can enter there, and the student, when falling back onto the training seat, does not clamp parts of the securing means with his/her back which are located behind.

According to a further embodiment, the training seat is optionally also rotatably supported around a “local rotary axis”. This means that it has a rotary axis which is fixed which or which is moveable within limits, which typically passes through it in vertical direction, and about which it can rotate, typically within limits. This embodiment is particularly advantageous if the training seat is located in a water-filled recess of a training device of the above-mentioned type. In this case, a tractive force of the flying apparatus results in a rapid rotation of the training seat, and to a delayed rotation of the entire training device.

Particularly preferred, the aforementioned training seat is combined with a training device of the type described before. For this purpose, the latter preferably has one or more of said recesses, in which the training seat(s) can be accommodated. Alternatively, the training seat or seats are located on the periphery of the training device. However, they are always preferably connected with it in such a way that only said tilting movement can be carried out by them.

The invention further relates to a method for operating a training device for learning the handling of flying apparatuses pulling persons, which has a platform for standing, sitting, kneeling or lying reception of at least one person, and at least one anchoring point for the fastening of a securing means which secures the person to the training device, and a vertical rotary axis about which the training device is rotationally supported, the rotary axis being, relatively to the platform, immovable, or movable within constructively predetermined limits. Therefore, particularly preferred, this is a training device of the type described above.

The method includes the steps: in particular, rear-sided) securing the person at the anchoring point lying in or above the height of the person's buttocks region; exerting external forces on the training device by means of the flying apparatus held by the person; and rotating the training device around its rotary axis due to said external forces; such that the training device automatically orients itself in such a way that the flying apparatus is located on the downwind side.

In other words: the person who trains is first secured to the training device, preferably in the area of his/her rear side. The anchoring point, by means of which he/she is connected to the training device, is arranged at least at the height of the buttocks region, preferably higher. The student is typically in a standing or sitting position. The flying apparatus is then brought into the air by the student, but in the initial phase also by the teacher. The flying apparatus is drawn from the wind to lee; the tensile forces run from the flying apparatus, which is in particular a kite, to the student, and from him/her via the securing means and the anchoring point to the body of the training device. The forces, which are typically eccentric (i.e. run not through the center of mass of the training device), result in a rotation of the training device about a rotary axis which is fixed or which is variable within predetermined limits, until the forces run straight through the center of mass. Unless not inhibited, only a linear movement of the training device is then performed.

If the rotary axis is provided by a rotary joint which is immobile with respect to the platform, and if the rotary joint is directly or indirectly connected with an anchoring, the training device does not move primarily linearly, but rather rotates until the above-mentioned, typically temporary, equilibrium of forces is established. Only slight “drifting” is possible within the range which is permitted by the play of the anchoring (e.g. cable with anchor). If the forces change, for example due to changing the wind direction or reversing the kite, again, a rotation of the training device takes place, and, if necessary, a further slight drifting occurs. The student can thus learn in a simple, controllable and reliable manner the handling of the kite and the reactions of his “board” which is represented by the rotatable platform. Because of the securing means, the student becomes tired less quickly, and safety against unintentionally falling off-board due to sudden high tensile forces because of the kite is significantly increased.

It is clear that the method according to the invention can also be used for a rotary axis which is moveable within predetermined limits. This means that the rotary axis can move (e.g. slide) freely along two points, wherein said points are structurally invariably predefined, and the associated end stops are firmly connected to the training device. Thus, the rotary axis is still stationary in the sense that it cannot be completely freely arranged, wherein the range of movement is structurally predetermined by components attached to the training device.

According to a preferred embodiment, the aforementioned connection with the anchoring (not to be confused with the anchoring point) is indirect, and is provided by means of a rope, a cable, or a chain. In other words, the floatable training device is not connected directly (fixedly) with the anchoring, but indirectly (elastically, flexibly, within limits), by means of a cable or the like.

The anchoring itself is preferably a floating body (e.g. buoy), an immersion body (e.g. water-filled tank floating in water), or a solid underground (e.g. ocean floor, weight, anchor). Depending on the tension of the indirect connection, the training device can then glide only a short distance on the water (drift) before it can perform exclusively the rotational movement described above.

According to a further embodiment, the training device is moved by means of a motor-driven vehicle, while the student trains on the kite. Thus, real driving situations can also be simulated with the student. This has further significant advantages with regard to the learning speed, as well as the safety of the student and the surroundings. In addition, due to the resulting airflow, it is possible to teach in situations of extremely low wind, which further improves the economic viability with regard to the use of the training device.

According to one embodiment, the motor-driven vehicle is connected to the training device on the stationary rotary axis. This means that the training device can also rotate about the rotary axis in the way described above during dragging, by means of which the wind for the kite is generated.

According to another embodiment, the dragging is carried out by means of the above-mentioned dragging device; since the latter is attached at a specific point in the edge region of the platform, a free rotation of the platform is then not possible (or only to a very limited extent).

The invention also relates to a method for operating a training seat for learning the handling of flying apparatuses towing people, wherein the training seat is designed according to the above description. According to the invention, the training seat, or at least tread surface of the latter is erected from a lying rest position due to tensile forces provided by the flying apparatus, together with the person which is attached to the training seat by means of the securing means. In this case, the seat or the tread surface, respectively, tilts forward around a tilt axis which runs perpendicular to the person's sagittal plane. The sagittal plane is the plane which divides the body into a right and left half. The tilt axis thus runs from left to right, wherein it does not necessarily run through the body, but can also be located in front of the feet or behind the back, and wherein the tilt axis can be fixed, but also variable. Apart from that, reference is made to the above explanations for tilting the training seat or the tread surface.

Preferably, erecting is limited by means of an inhibiting device which is also described further above. This means that at a pre-selectable angle of, for example, 80, 90, or 100 degrees of the seat, or an angle of, for example, 80 to 130 degrees of the tread surface (in each case, to the horizontal) the erecting movement is stopped.

Optionally, the securing means allow a certain freedom of movement of the person in the forward direction. Then, firstly, the person is raised before taking along the training seat which can be tilted as a whole, and which holds back the person if necessary after completely erect. It is clear that the movement is reversed when the tensile forces are reduced.

According to a further embodiment, the training seat is rotated around a vertical local rotary axis due to transverse forces originating from the flying apparatus; preferably, until said forces become zero. Accordingly, transverse forces are forces which do not run exactly in the sagittal plane, but at an angle thereto. For rotatability, the training seat provides an according local rotary axis, which can be provided by a rotary joint, but also by placing the training seat in the water. If the training seat is located on a training device of the above-mentioned type, thus, via the rotary joint or the side walls of the training seat (when the latter floats in a recess), forces act on the platform such that the platform also begins to rotate until the transverse forces disappear.

The operation of the described training device and of the training seat by means of the respective method according to the invention allows to carry out training lessons without risk, and remote from highly frequented zones. Endangering of kite students, of passers and other kiters is minimized. Learning successes can be achieved significantly more quickly and with less efforts. The student can learn more relaxed with less stress and more joy. In addition, the kite teacher is also relieved and can be teach more effectively and safely. Training in each wind direction is enabled, so that significantly more trainings can take place.

### DESCRIPTION OF THE DRAWINGS

FIG. 1 shows a schematic side view of a preferred embodiment of the training device.

FIG. 2 shows schematically an embodiment of the training device with a rotary axis which is stationary within predefined boundaries.

FIG. 3 shows a top view of a preferred embodiment of the training device.

FIG. 4 shows a schematic three-dimensional view of the training device.

FIG. 5 shows schematically the situation with forces acting eccentrically to the training device.

FIG. 6 shows schematically the situation after rotation of the platform, and with external forces running through the center of mass.

FIG. 7 shows schematically a training seat with tilt axis in the region of the tread surface.

FIG. 8 shows schematically a training seat which is tiltable as a whole in the form of a half shell with a rear side in the form of a circular segment.

FIG. 9 shows schematically a training seat with tiltable tread surface in a side view;

FIG. 10 shows schematically the training seat with tiltable tread surface at an angle from the front;

FIG. 11 shows schematically a tiltable tread surface with transverse rod in a perspective view;

FIG. 12 shows schematically a tiltable tread surface without transverse rod in a perspective view;

FIG. 13 shows schematically training device with a training seat arranged in a recess; and

FIG. 14 shows schematically an embodiment of the tread surface.

### DETAILED DESCRIPTION OF PREFERRED EMBODIMENTS

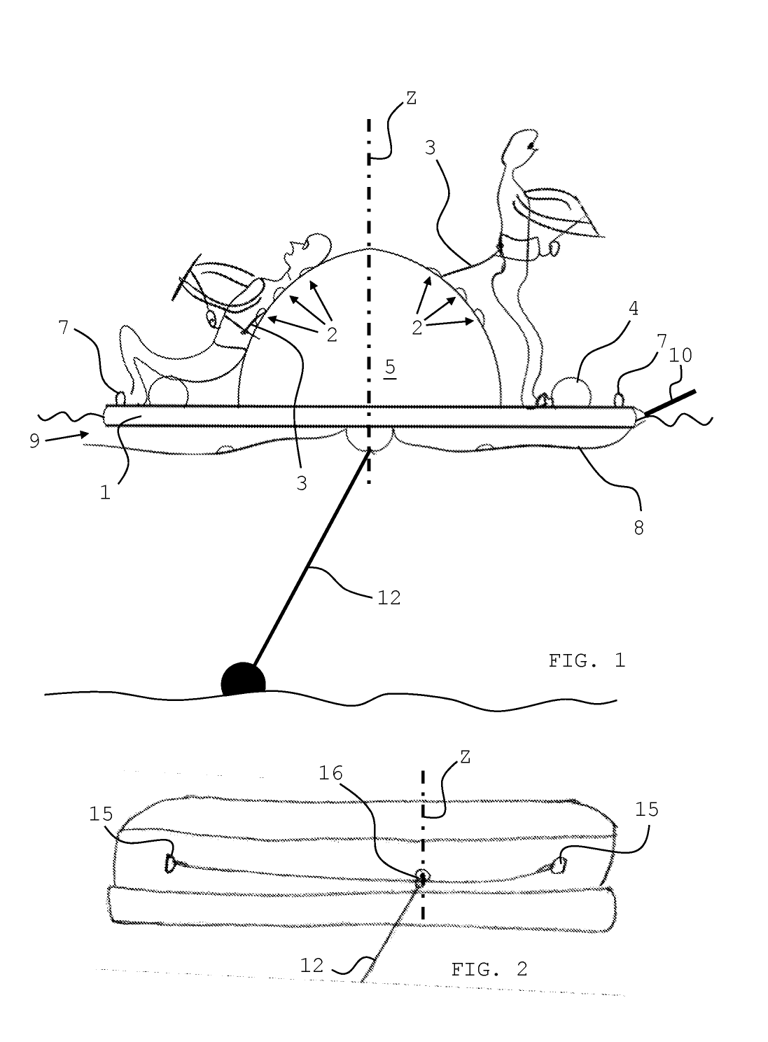

In FIG. 1, a schematic side view of a preferred embodiment of the training device is depicted. It has a platform 1. In the case at hand, two persons a present, one of which is in a standing, the other in a sitting position. The depicted embodiment is floatable and can glide along the water surface. Platform 1 is provided as floating body which provides permanent buoyancy.

In the central region, presently in the center, of platform 1, a support body for the back 5 is arranged. Multiple anchoring points 2 are attached to the same for attachment of securing means 3 which are intended to secure persons to the training device. In the present case, the anchoring points 2 are designed as eyelets, and the securing means 3 are designed as lines. The anchoring points 2 are arranged in or above the height of the buttocks region of the person. This has the advantage that a person who must absorb the tensile forces of the kite is relieved, since the tensile forces are diverted by the securing means 3 which is arranged behind the back, without the person being e.g. pulled to the ground which would be the case when the anchoring point 2 would be arranged at the floor, and/or the kite would fly very close to the water surface. In other words, by the raised arrangement of the anchoring point 2, a linear running flux of force from the flying apparatus over its lines to the harness of the student, and, while keeping said linear orientation, further from the student to the body of the training device. Thus, the tensile force vector runs in a straight line from the flying apparatus to the body of the training device. This is done by intersecting with the body of the student, whereby the forces are directed around him/her by appropriate auxiliary means (harness, support frame) such that the student him/herself does not have to absorb all tensile forces. If he/she stems against the kite such that the securing means 3 is temporarily without tension, he/she can take temporarily full control of the kite. In case of a sudden gust or fatigue, he/she can divert the forces to the body of the training device via the securing means 3 instead via his/her own body.

The platform 1 comprises also a support body for the feet 4 which is arranged circumferentially in the edge region of the platform 1. A person who controls the kite (not shown) and who tries to absorb the tensile forces of the same can rest against this support body 4. Further, the platform 1 comprises also holding means 7 for the feet.

Depicted is further the vertical rotary axis Z, about which the training device is rotatably supported. Since the training device is not attached firmly to an underground in all degrees of freedom, it can be set in rotation by means of external forces. In particular, it can rotate due to the tensile forces which are provided by a kite, and which are forwarded from the latter by means of the lines to the student, and from there, via the securing means 3 and the anchoring point 2 to the body of the training device. The depicted embodiment has a completely stationary rotary axis Z. The latter is determined by the position of a rotary joint which is arranged at the underside of the platform 1 in its center. To the rotary joint, a rope 12 is attached which is connected with the underground, and which has, in the case at hand, a weighted end. It is clear that, depending on the tension of rope 12, the training device can drift horizontally on the water surface; a very strong tensioned rope or a vertical rod allow virtually no drifting. However, from the viewpoint of the students on the platform, this drifting is hardly noticeable compared to the possible rotations about vertical rotary axis Z.

When the training device is not connected with the underground, it provides a completely variable rotary axis. The drifting the allows for a simultaneous rotating, the rotary point is however not defined any more.

Even when the training device is dragged e.g. by a boat with rope 12 (e.g. for the generation of “artificial” wind), it can—in addition to the drifting motion which is imposed to the platform by the boat—still rotate about the defined rotary axis Z; the latter is still completely stationary. It is clear that it has to be ensured that a free rotation is not impeded by components colliding with one another.

On its underside, the platform 1 has a braking body 8 which is connected to it and which can be filled with water. In the present case, the latter is produced from a flexible, tarpaulin-like material, so that a flat, inflatable volume is provided. The braking body 8 forms an additional underbody below the platform 1 and has an opening 9, through which it can be filled and emptied. In the situation shown, it is largely filled, so that it significantly contributes to the capsizing safety of the training device. Due to the flat design of the braking body 8, the latter does not, or only very little, impede the rotation of the training device, even in the filled state.

If the training device is now dragged to the right in the image, for example by means of a dragging device 10 (on the right in the image; only schematically and partly shown), the platform 1 is slightly lifted on the side of the dragging device 10. Surface water flows under the platform 1 and thus under the braking body 8. The water contained in the volume thereof is thereby forced out through the opening 9; the platform becomes lighter and better maneuverable. If the training device stagnates, the volume is automatically filled with water again.

In order to achieve the described effect of emptying, the dragging device 10, seen in a view parallel to the rotary axis Z, attaches to the region of the training device lying opposite the opening 9 of the braking body 8.

FIG. 2 shows schematically an embodiment of the training device with a rotary axis which is stationary within predefined boundaries. Presently, the latter is provided by means of a coupling element 16 (roller) which is slidably moveable between two end stops 15 (eyelets), the coupling element 16 being able to glide along a rope.

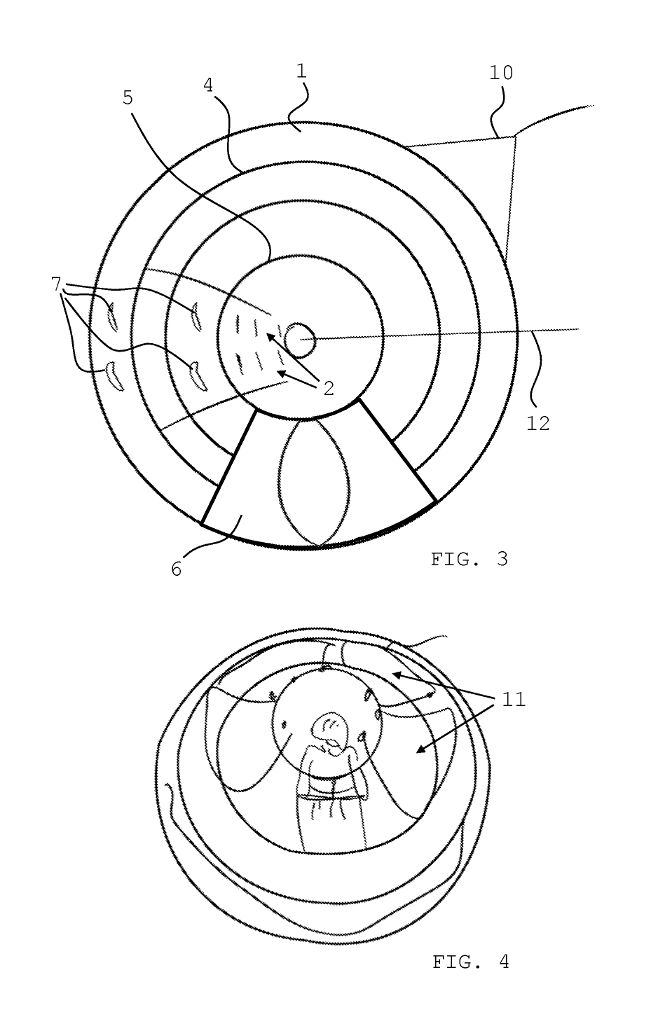

FIG. 3 shows a top view of a preferred embodiment of the training device. It can be clearly seen that the same has a circular base surface. The centrally arranged support body for the back 5 is also round. The persons have been omitted in the figure for reasons of clarity. Visible is the (almost) circumferential support body for the feet 4, and (shown for one student only) anchoring points 2 and holding means 7 for the feet. The “training segment” shown can be present in a single or multiple manner on the platform 1.

In the embodiment shown, further, a recess 6 is provided on the platform 1. The recess 6 serves to receive a board-like sports device provided by a rigid-designed support body for the feet 4 (without reference numeral, not to scale). The latter is mounted in a tilting and rotatable manner (bearings not shown), so that a student on the device can perform according movements, in particular when he/she simultaneously controls a kite. However, the recess can also be provided for a training seat which is illustrated further below.

FIG. 4 shows a scaled down schematic three-dimensional view of a training device obliquely from above. Reference numerals already introduced are omitted for reasons of clarity. A person who holds a bar (without reference numeral) is shown on this training device. Two lines (without reference numeral) extend from the bar to a kite (not shown). A tensile force is exerted on the student by means of the lines; by means of the (not visible) securing means 3 and the anchoring point 2 the forces can be dissipated to the body of the training device.

Furthermore, seats 11, which are illustrated transparently, can be seen, which are tensioned between the support body for the feet and the support body for the back. Reference is made to the above explanations with regard to the advantages of such seats.

FIG. 5 shows the schematic plan view of the training device when tensile forces which originate from the kite and which act on the training device and do not run (viewed in a plan view) through its center of mass. The platform 1 is attached to the underground by means of a rope 12, the rotary axis Z is therefore stationary relative to the platform 1.

In the image, the lines of the kite (not shown) run to the top left; the dash-dotted line indicates the (summed) tensile force vector of the external forces. The line initially does not run through the centre of mass/the rotary axis Z. Therefore, the training device is set into a rotational movement (arrow 13 top right). Also, the centre of the training device drifts in the direction of the dashed arrow 14; the latter lies on a circular path with the centre point at the end of the rope 12 (black circle; e.g. anchor or weight). The plane of the force vector and of the cable that is perpendicular to the image do not coincide, but are at an angle W to one another.

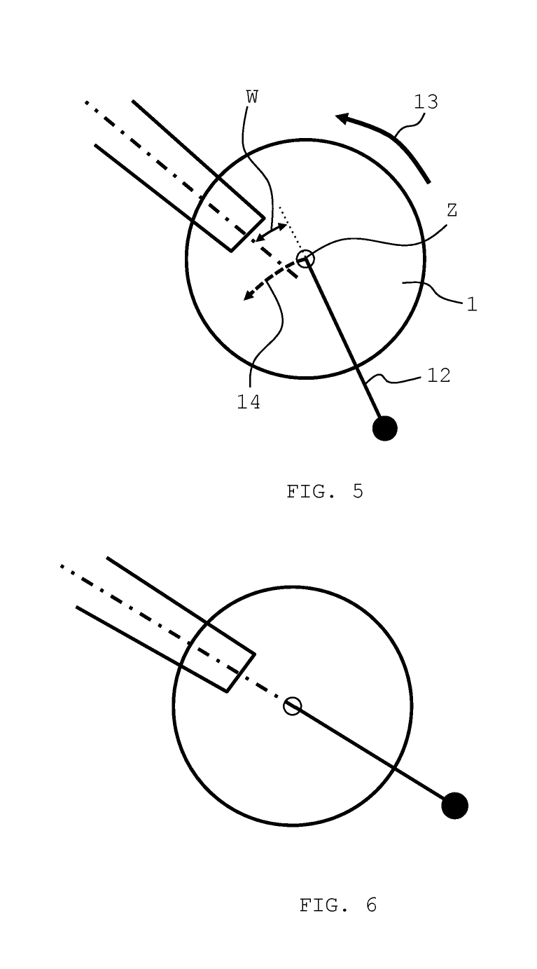

In FIG. 6, in which the reference numerals have been omitted, the rotation of the platform 1 has come to a standstill, since the force vector now runs through the rotary axis Z. It also lies in the same plane as the rope 12, which dissipates the forces to the underground, said forces travelling via student, securing means and anchoring point (respectively not shown) into the body of the training device, and from there, via the rotary joint to said rope. The equilibrium shown is disturbed by steering the kite to another point; the equilibrium is restored by a further rotation and optional drift of the training device.

FIG. 7 schematically shows a training seat with a tilt axis Y in the region of the tread surface 18. The training seat can tilt forward in the direction of the sagittal plane of the student about this tilt axis Y, which can be provided, for example, by a transverse rod or belts. The student can be retained on the seat by means of suitable securing means 3. Also visible are parts of the inhibiting device 19, which ensures that the student can tilt forward together with the seat only up to a maximum angle. The inhibiting device can be attached to a fixed underground (platform 1, landing stage, boat, . . . ). Accordingly, the tilt axis Y is stationary. Holding means 7 for the feet (not shown) are arranged on the tread surface 18 as loops that can be adjusted in size and position.

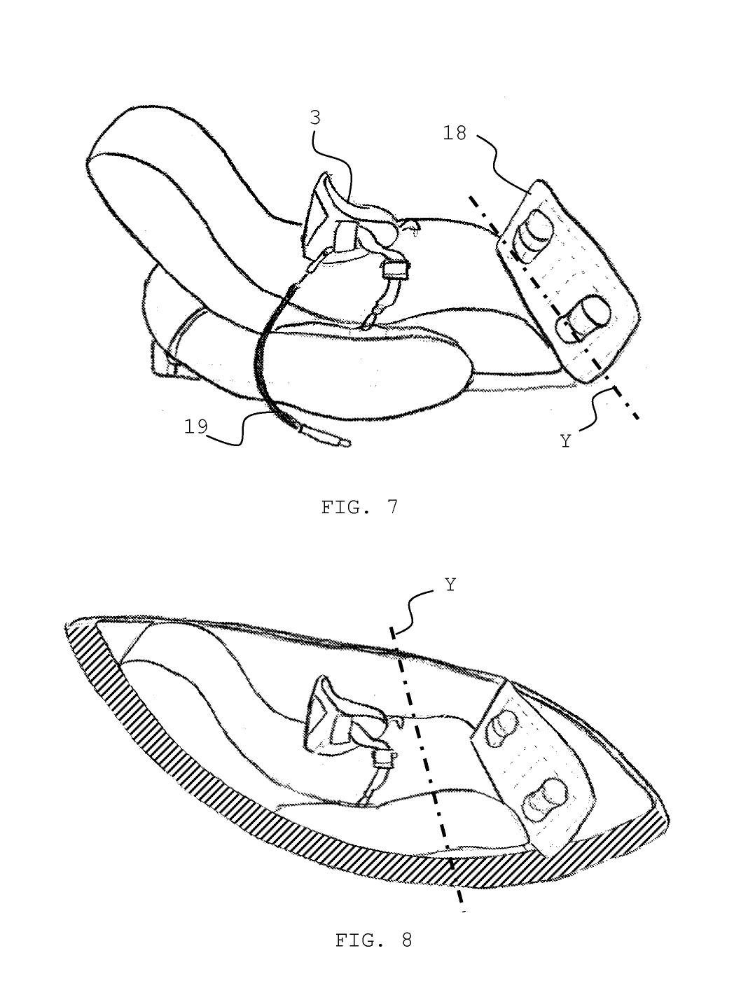

FIG. 8 shows an entirely tiltable training seat in the form of a half-shell, shown in section, which has a rear side in the form of a circular arc. The rear side of the half shell can be equipped with a rigid guide track which can slide in a corresponding frame, so that the tilting movement is made possible.

It is also possible for the training seat to be floatable and to have a rear side in the form of a circular segment, so that it can slide in the water on a circular-segment-shaped path. According to this embodiment, the rotary axis is variable within limits.

FIG. 9 schematically shows a training seat in a side view having only a tiltable tread surface. The seating area 17 is fixedly connected to the platform 1. The tread surface 18 has the tilt axis Y according to the invention. However, since the tread surface is part of the training seat, the tilt axis Y is also part of the training seat. To the side of the tread surface 18A a post 21 is attached, the end of which extends approximately as far as the buttocks region of the seating area 17. During raising from the continuously-drawn rest position to a raised position drawn in dashed lines, the post 21 tilts forward together with the tread surface 18 until the tread surface 18 runs approximately parallel to the water surface (not shown).

The neck support 24 shown is preferably designed to be adjustable.

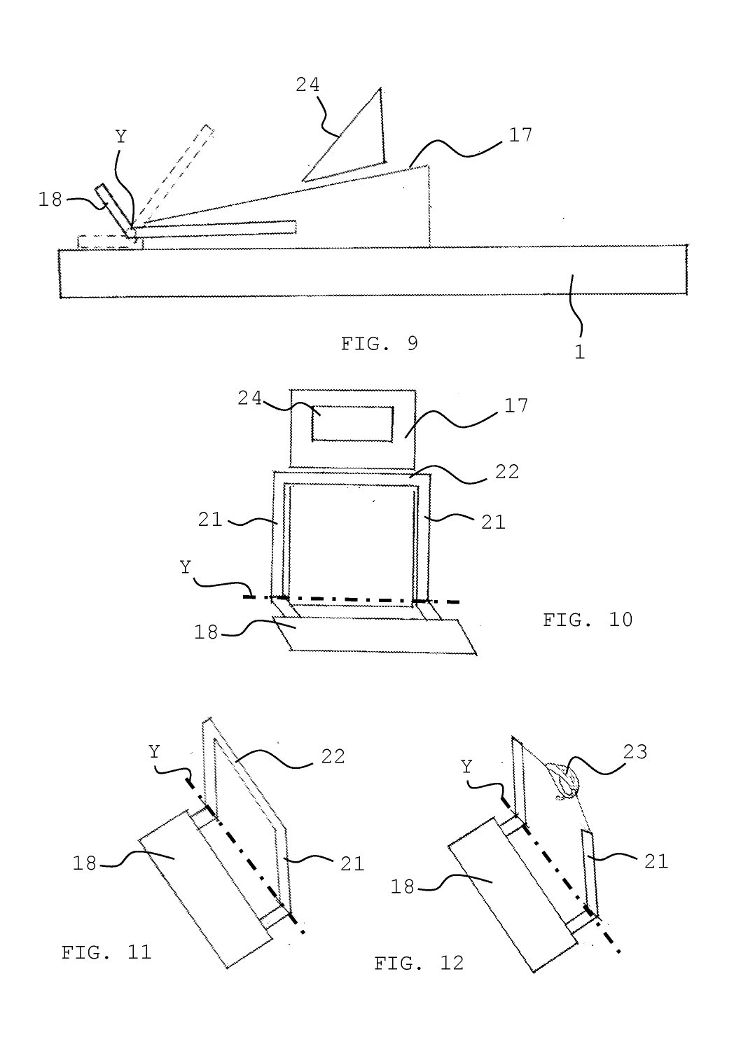

FIG. 10 schematically shows the training seat with tiltable tread surface obliquely from the front. The platform is omitted in this view. The two posts 21, as well as a transverse rod 22 can be clearly seen. In the seating area 17, a recess (without reference numeral) is present, into which the transverse rod 22 can enter.

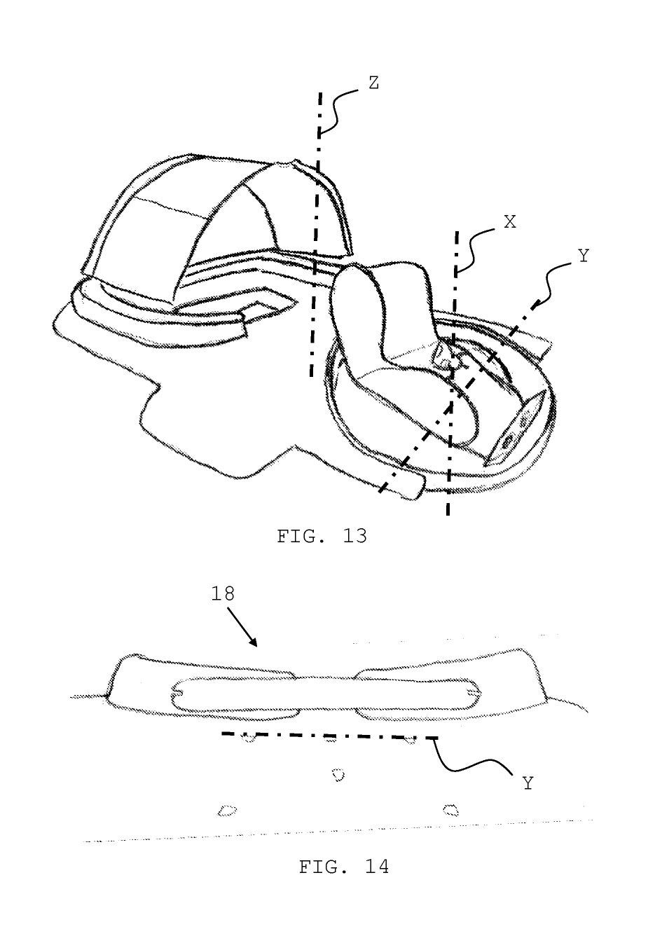

FIG. 11 schematically shows a tiltable tread surface with a transverse rod 22 in a perspective view. Instead of the transverse rod, a harness 23 which is part of the securing means 3, fastened to wires or belts, can be attached between the ends of the posts 21 (FIG. 12).

FIG. 13 schematically shows a training device with a training seat arranged in a recess. The training device accordingly comprises only a single training seat in this exemplary embodiment. In the rear region, space is provided for further students. The training seat can be rotated about a “local” rotary axis X, and can be tilted about the tilt axis Y; the latter is located below the training seat, since it can tilt on the water. The training device itself is still rotatable about the “global axis of rotation Z”.

Finally, FIG. 14 shows a special embodiment of the tread surface 18, which is suitable in particular for a training seat which can be tilted as a whole. Since high forces can develop during the forward-tilting of the training seat into the vertical, it is advantageous to cushion the tread surface 18. If the underground is soft (water and possibly inflatable floating body), it is helpful to compensate for this. The figure shows a board 20 which is attached to two inflatable air cushions. In the upright state of the training seat, the tread surface 18 presses centrally onto said air cushions. By filling or emptying the air cushions, the inclination of the tread surface 18 can be varied. This could, of course, also be achieved by means of a mechanically adjustable tread surface (not shown).

The semi-circles visible in the lower region of the figure represent the fastening points of the training seat, wherein the three upper ones can be used simultaneously as the tilt axis Y.

### LIST OF REFERENCE NUMERALS

1 platform
2 anchoring point
3 securing means
4 support body for the feet
5 support body for the back
6 recess
7 holding means
8 braking body
9 opening
10 dragging device
11 seats
12 rope
13 arrow
14 arrow
15 end stop
16 coupling element
17 seating area
18 tread surface
19 inhibiting device
20 board
21 post
22 transverse rod
23 harness
24 neck support
Z rotary axis
Y tilt axis
X local rotary axis
W angle

1. A training device for learning the operation of a flying apparatus that pulls a person, the device comprising:
a platform (1) for the standing, sitting, kneeling or lying reception of at least one person;
at least one anchoring point (2) for the fastening of a securing means (3) which secures the person to the training device; and
a vertical rotary axis (Z), about which the training device can be mounted rotatably or is mounted rotatably;
wherein the anchoring point (2) is arranged in or above the height of the person's buttocks region, and the training device is rotatable around this rotary axis (Z) by means of forces acting on the platform (1), characterized in that the rotary axis (Z) is completely, or within constructively predefined limits, stationary relative to the platform (1).

2. The training device according to claim 1, wherein the completely stationary rotary axis (Z) is provided by means of a rotary joint which is located at the underside, at the circumference, or at the upper side of the platform (1).

3. The training device according to claim 2, wherein the rotary axis (Z) which is stationary within constructively predefined boundaries is provided by means of a coupling element (16) which is slidably moveable between two end stops (15).

4. The training device according to claim 1, further comprising skids or a slidable underside for the locomotion on ice and snow, or rollers for the locomotion on solid grounds.

5. The training device according to claim 1, wherein the device is floatable.

6. The training device according to claim 5, further comprising a floating body which provides a permanent or temporary buoyancy.

7. The training device according to claim 1, further comprising a support body for the feet (4), and/or a support body for the back (5) of a person, and wherein the support body/bodies (4, 5) is or are located at the edge of the platform (1) or at the central region of the platform (1).

8. The training device according to claim 7, wherein the support body for the feet (4) has a region which can, by means of the feet of a person, be tilted laterally or forward/backward, and/or be rotated around a central axis, and wherein the support body (4) is designed either as a body which is deformable by the feet, or as a rigid body which is supported moveable on the platform (1) according to said degrees of freedom.

9. The training device according to claim 8, wherein the platform (1) comprises a recess (6) at its circumference, wherein the recess (6)
is provided for the reception of a board like sports device serving as a support body for the feet (4), wherein the sports device can be supported in the recess (6) according to said degrees of freedom, or
has a deformable floor and provides holding means (7) for a fixation to a person's feet, and
is suitable for the reception of a separate training seat which receives a person.

10. The training device according to claim 5, further comprising at least one braking body (8) which is located below or laterally to the platform (1) and which is attached to the same, and which is or can be filled with water or a solid material.

11. The training device according to claim 10, wherein the braking body (8) is provided by means of an additional subfloor or two skids, and has at least one opening (9) through which it can be filled and/or emptied.

12. The training device according to claim 1, further comprising a dragging device (10), wherein the same engages—if applicable, in a view parallel to the rotary axis (Z)—in a region opposing to the at least one opening (9) of the braking body (8).

13. The training device according to claim 7, wherein seats are stretched between the support body for the feet (4) and the support body for the back (5).

14. The training device according to claim 1, further comprising a motor drive and/or a mounting for a vehicle suitable for the pushing and/or pulling propulsion of the training device.

15-24. (canceled)

25. A method for the operation of a training device for learning the operation of a flying apparatus for pulling a person, the training device having a platform (1) for the standing, sitting, kneeling or lying reception of at least one person; and at least one anchoring point (2) for the fastening of a securing means (3) which secures the person to the training device; and a vertical rotary axis (Z), about which the training device is rotationally supported, the rotary axis (Z) being, relatively to the platform (1), immovable, or movable within constructively predetermined limits; the method comprising the steps:
securing the person at the anchoring point (2) lying in or above the height of the person's buttocks region;
exerting external forces on the training device by means of the flying apparatus held by the person; and
rotating the training device around its rotary axis (Z) due to said external forces;
such that the training device automatically orients itself in such a way that the flying apparatus is located on the downwind side.

26. The method according to claim 25, wherein the rotary axis (Z) is provided by a rotary joint, and wherein the rotary joint is directly or indirectly connected with an anchoring.

27. The method according to claim 26, wherein the connection is indirect, and is provided by means of a rope, a cable, or a chain, and wherein the anchoring is a floating body, an immersion body, or a solid underground.

28. The method according to claim 25, wherein the training device is moved by means of a motor driven vehicle.

29. The method according to claim 28, wherein the motor driven vehicle is attached at the stationary rotary axis (Z) to the training device, so that wind for the flying apparatus is generated, while the training device can rotate around its rotary axis (Z).

30. A method for the operation of a training seat for learning the operation of a flying apparatus for pulling a person, wherein the training seat has a seating area (17) for receiving the person, an inclined tread surface (18) for supporting the feet of a person, as well as securing means (3) for holding back the person to the training seat, characterized in that at least the tread surface (18) of the training seat is erected from a lying rest position due to tensile forces provided by the flying apparatus, together with the person which is attached to the training seat by means of the securing means (3), whereupon at least the tread surface (18) tilts forward around a tilt axis (Y) which runs perpendicular to the person's sagittal plane.

31. (canceled)

32. (canceled)
